(19) United States
(12) Patent Application Publication
(10) Pub. No.: US 2008/0120022 A1
(43) Pub. Date: May 22, 2008

(54) Method and Device for Determining a Route with Points of Interest

(75) Inventors: Pierre Hayot, Clamart (FR); Michel Raynaud, Fontenay-Sous-Bois (FR)

Correspondence Address: BUCHANAN, INGERSOLL & ROONEY PC, POST OFFICE BOX 1404, ALEXANDRIA, VA, 22313-1404, US

(73) Assignee: Societe De Technologie Michelin, Clermont-Ferrand (FR)

(21) Appl. No.: 11/883,811

(22) PCT Filed: Feb. 1, 2006
(86) PCT No.: PCT/EP06/00862

§ 371 Date: Nov. 20, 2007

(30) Foreign Application Priority Data
Feb. 7, 2005 (FR) 0501187

(51) Int. Cl. G01C 21/34

(52) U.S. Cl. 701/202

(57) ABSTRACT

A method for determining routes for a digital road network system on the basis of a main route connecting a starting point to a finishing point. The method makes it possible to reach a point of interest (POI) reachable by a plurality of secondary routes intersecting the main route. An optimal POI overall route is determined by performing the following steps. First, a POI overall route is evaluated for each of the potential secondary routes on the basis of at least the following route elements: (1) a useful portion of a main route and a corresponding score, the score being assigned a factor “k” lying between 0.1 and 0.7, and (2) the chosen secondary route and a corresponding score. Then, the POI overall route whose resulting score is optimal is chosen.

The present invention relates on the one hand to a method for determining routes for a digital mapping system in which, on the basis of a main route connecting a starting point, selected from a database, to a finishing point, also selected from a database, said method furthermore making it possible to reach at least one point of interest, and on the other hand to a method for selecting points of interest, for a digital mapping system in which, on the basis of a main route connecting a starting point, selected from a database, to a finishing point, also selected from a database, in which the POI overall route, determined with the preceding method, is used to select at least one point of interest. The invention also envisages a corresponding route calculation device, digital mapping system and software.

The known procedures for identifying and presenting points of interest generally make it possible to locate on a map certain points of interest, depending on their direct geographical proximity (that is to say “as the crow flies”) with respect to a given route.

Such an approach comprises several practical drawbacks: certain points may be difficult to access from the given route. Thus for example, points may be situated near an expressway, without however there being any exit in proximity. The access time may therefore be particularly long. Points may be accessible only after a journey requiring a time that is a priori disproportionate with respect to the actual distance. It is possible to encounter this kind of situation for example when crossing a mountain pass, or when traveling through built-up areas with no expressway.

Situations where a multiplicity of points are proposed in a restricted radius are also encountered, and this may cause the user certain difficulties, as he no longer knows on what basis he can select a point from among a large number of possibilities.

These various solutions are in general easy to implement, since they do not take into account:

possible difficulties of access;

the additional time required between the main route and the point of interest;

the possible difficulty of the extra journey;

the direction of the journey.

The known solutions are aimed at giving the user maximum information that he will then have to process/analyse himself. However, in most cases, the user who calls upon this type of service is largely or completely unfamiliar with the region in question or at the very least with the details of the road network. He may therefore against his better judgement make choices that are expensive in terms of journey time or additional distance to be traveled. All these factors can contribute to affecting the pre-established route which becomes disrupted or modified to a greater degree than one might have wished.

FIG. 7 presents a known example of a route determination method, in which the journey time on the secondary route is given priority so as to select a route for getting to this point, from an already known main route. In such a case, although the journey time on the secondary route is optimized, the overall journey may entail a detour with respect to another route which would be more judicious as a whole.

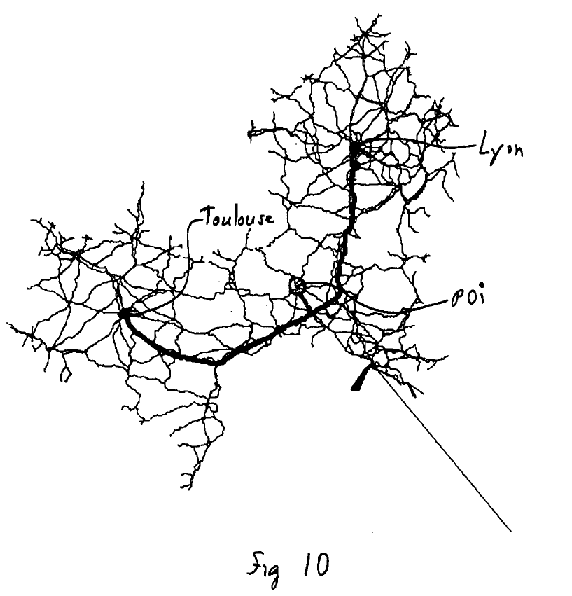

FIG. 8 presents another known example of a route determination method, in which the journey time from the origin to the point of interest is given priority so as to select a route for getting to this point, from an already known main route. In such a case, although the overall journey time is optimized, the journey time and/or length over the chosen portion of secondary route may entail a disproportionate time or distance, on a route that may present more difficulties relative to the main route, as opposed to another route which would be more judicious as a whole.

In order to avoid these various drawbacks, and in particular in order to identify the points allowing the user to preserve an optimal overall route, there is proposed a method for determining routes for a digital road network system stored on a memory medium and comprising a plurality of sections and of positioning indications for these sections, said sections being capable of being arranged in a reconstruction of a road network so as to form road portions and junctions, in which method, on the basis of a main route connecting a starting point, selected from a database, to a finishing point, also selected from a database, said route being constructed from sections and possibly nodes, said sections connecting said nodes, said method furthermore making it possible to reach at least one point of interest (POI) (present in a database, whether it be the same or another database) reachable by a plurality of secondary routes intersecting the main route, an optimal POI overall route is determined by performing the following steps:

a POI overall route is evaluated for each of the potential secondary routes on the basis of at least the following route elements:

a useful portion of main route and a corresponding score, said score being assigned a factor “k”, the value of said factor “k” lying between 0.1 and 0.7, and preferably between 0.3 and 0.5;

the chosen secondary route and a corresponding score;

the POI overall route whose resulting score is optimal is chosen from the set of evaluated POI overall routes.

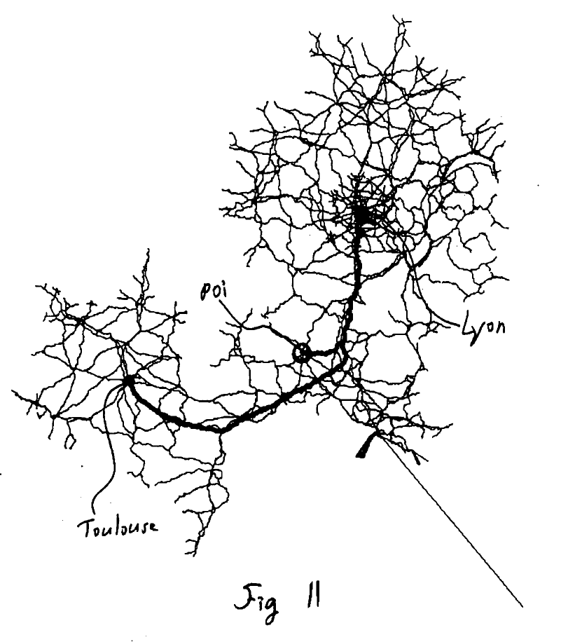

The present method makes it possible to circumvent the step of preselecting POIs, for example POIs present in a given radius around the route, without taking account of whether or not these POIs are connected to the road network in question. This elimination of the preselection step makes it possible to considerably reduce the calculation time and thereby even the resources necessary to perform the calculations. This feature of the invention is very visible in FIGS. 10 and 11 where it may be noted that the phase of exploring the graph is substantially more restricted as the value of k decreases. FIGS. 10 and 11 illustrate the cases where k equals 0.1 and 0.7, respectively. The number of explored sections is larger in FIG. 11 (for k=0.7) than in FIG. 10 (k=0.1). This presents a direct positive impact on the calculation time, the capabilities required to perform these calculations and the costs.

Moreover, by virtue of this method, an optimal POI overall route is obtained which takes account of the direction of the main route and prevents aberrant or absurd results being obtained.

In an advantageous manner, the POI overall route consists of said useful portion of main route combined with the chosen secondary route.

The optimal score is preferably the lowest. According to an advantageous embodiment, the score corresponds to the journey time. The optimal score thus corresponds to the minimum journey time.

According to an advantageous embodiment, the origin of the useful portion of the main route is the starting point of the main route.

According to another advantageous embodiment, the origin of the useful portion of the main route is the first intersection point between the main route and one of the potential secondary routes, taking account of the direction of the main route.

In a preferred manner, the digital network also comprises nodes, making it possible, in a representation of the road network, to join together a plurality of sections.

According to an advantageous embodiment, in order to determine a route, a plurality of potential roads is identified from which a route is elected on the basis of given criteria, the identification of the plurality of roads being performed by selecting a first modeling element for the road network, preferably a node, in proximity to the starting point, and a second modeling element for the road network, preferably a node, in proximity to the finishing point; identifying a plurality of roads, each consisting of a plurality of connected road elements from the first element to the second element; and searching for at least one intermediate element for each of said roads in said set of road network modeling elements. This may be a main route and/or a secondary route.

In an advantageous manner, the exploration of the nodes is performed with the aid of the Dijkstra algorithm. According to a variant embodiment, it is also possible to perform the exploration with the aid of the FORD algorithm.

The invention moreover envisages a method of selecting points of interest (POI) for a digital mapping system in which, on the basis of a main route connecting a starting point, selected from a database, to a finishing point, also selected from a database, said route being constructed from sections and possibly nodes connecting said sections, in which a plurality of POI overall routes, determined with the method according to one of the preceding claims, is used to select a plurality of POIs.

The invention also envisages a piece of software comprising code elements programmed for the implementation of the methods presented above, when said piece of software is loaded into a computer system and executed by said computer system. Said piece of software is advantageously in the form of a product recorded on a medium readable by a computer system, comprising programmed code elements.

Lastly, the invention envisages a route calculation device, comprising:

a data entry unit, intended to receive the data associated with a starting point and those associated with a finishing point;

an access to a storage unit comprising a set of elements for modeling a road network;

a calculation unit devised to identify a plurality of roads each making it possible to connect the starting and finishing points;

evaluation means, making it possible to evaluate, for a plurality of potential secondary routes connecting the main route to at least one point of interest, a POI overall route on the basis of at least the following route elements:

a useful portion of main route and a corresponding score, said score being assigned a factor “k”, the value of said factor “k” lying between 0.1 and 0.7, and preferably between 0.3 and 0.5;

the chosen secondary route and a corresponding score;

and making it possible to choose, from all the evaluated POI overall routes, the POI overall route whose resulting score is optimal.

The device preferably comprises a guidance unit, devised so as to generate guidance information as a function of the mapping elements of the selected road.

Lastly, the invention envisages a computer system comprising a device as described in the foregoing.

According to various alternative embodiments, the procedure can serve to present the various identified points of interest to the user, for example on a map. The points can also be presented on a route sheet (a list of instructions to be followed to take a predetermined route). The user processes the information obtained at his leisure and at his convenience.

All the embodiment details are given in the description which follows, supplemented with FIGS. 1 to 11 in which:

FIGS. 1 to 6 illustrate a preferential mode based on the Dijkstra algorithm, making it possible to determine a route, whether it be a main or secondary route;

FIGS. 7 and 8 illustrate examples of a mode of selecting secondary routes of known type;

FIG. 9 illustrates an exemplary use of the method according to the invention;

FIGS. 10 and 11 illustrate the sections considered during the implementation of the method according to the invention with various values of k.

In the present description, the following terms are used in particular with the following meanings:

“Node” denotes an intersection point between a first mapping or road network element (or other network) and a second element of such a network, in particular the intersection between a plurality of road lanes. A node also denotes a point of physical or qualitative change of a section, such as for example a switch from two to three lanes, a change of speed limit, a zone (even temporary) subject to roadworks, a break point such as a border, etc.

“Section” denotes a portion of lane between two nodes.

“Route” denotes a subset of points arising from the elements for modeling a road network, creating a link between data so as to enable them to model or represent a journey or path over said road network that makes it possible to connect a starting point and a finishing point. This subset consists of the data relating to the sections that make it possible to connect the start and finish. The expression data relating to the sections is understood to mean the identifications, the lengths of the sections and the spatial coordinates.

This subset can serve to represent said route in various forms, for example by means of a graphical representation, preferably in the form of a map comprising the starting point, the finishing point, and the sections forming said route, or in the form of a “route sheet” or list of instructions, comprising an enumeration or series of instructions, written or represented by pictograms, explaining to a possible driver of a vehicle, the various steps to be followed to take said route.

The term POI is derived from the common terminology “Point Of Interest”, hence POI, which is used in this document.

“Main route” denotes the route between the starting point D and the finishing point A without taking account of the point of interest POI;

“secondary route” denotes the route between the main route and the POI;

“potential secondary route” denotes one of the possible secondary routes;

“useful portion of main route” denotes the portion of the main route situated between the point D and an intersection point INT between the main route and a potential secondary route (the intersection point is preferably a node);

“POI overall route” denotes the route (to be optimized) comprising a portion of main route and a secondary route;

“chosen secondary route” denotes the secondary route which is integrated with the optimal POI overall route and which optimizes the journey to the point of interest. This route is situated between the intersection point situated at the end of the “useful portion of main route” and the point of interest.

FIG. 9 illustrates an example of calculating a route and selecting a point of interest according to the method of the invention. The main route 1 between the starting point D and the finishing point A is either previously established or already known. On the basis of this route, one or more points of interest POI must be identified and selected, taking account of the main route 1 and its characteristics, in particular its direction, the journey times for the various sections 2 and the position of the nodes 3.

In the example illustrated, a point of interest POI is capable of being reached via three different secondary routes 4 and on the basis of distinct nodes 10, 20 or 30. The method makes it possible to determine an overall route that optimizes at one and the same time the use of the main route, since the latter is known, and the secondary route.

Therefore, the inventors have noted that it is necessary to consider the main and secondary routes, or the scores corresponding to these routes, on different bases, for example with the use of the following relation:

Score(Overall route)=k×Score(main route)+1×Score(secondary route)

k lying between 0.1 and 0.7.

Moreover, particularly advantageous results are obtained with the use of a value of k between 0.3 and 0.5.

This relation is used when determining each of the potential routes. Thus, for each of these potential routes that make it possible to get to the point of interest, a POI overall route is evaluated. The respective scores of each of the overall routes are thereafter compared and the overall route whose score is optimal is chosen. To perform these operations, only the useful portion of the main route is considered, that is to say the portion that is actually used of the main route to get to the chosen secondary route.

FIG. 9 presents the results obtained in the three cases that may be used in this example. First of all, following the direction of the main route—left to right in the figure, as indicated by the arrow in proximity to the finishing point—, the score of the first node 10 encountered is determined. Using scores based on this first node 10, a first score equivalent to that of the secondary route, i.e. 15 minutes, is obtained. Specifically, for this first node, the main route is not involved. For the second node 20, the score of the section 2 situated between the first 10 and the second node 20, i.e. 10 minutes, is multiplied by the factor k (0.5 in this example). The score of the associated secondary route, i.e. 6 minutes, is then added to obtain an overall route score of 11 minutes.

A similar process is performed for the third node 30: in this case, the score of the useful portion of the main route is 18 minutes (10′+8′), and that of the secondary route is 5 minutes. Multiplying the factor k (0.5) by the score of the useful portion of main route gives 9 minutes. The overall score is therefore 14 minutes (9+5).

On comparing the three overall scores, the most advantageous, preferably the lowest, that is to say that corresponding to the second node, 11 minutes, is chosen. The chosen secondary route is therefore that between this second node 20 and the point of interest POI (scored at 6′).

FIGS. 10 and 11 show that this method not only makes it possible to determine a more advantageous overall route, but especially makes it possible to reduce the extent of the sections to be considered, therefore reducing the calculation time. These figures show all the sections which are considered when a given point of interest POI (Alès) on a main route between Lyon and Toulouse is considered. In FIG. 10, the factor k considered has a value of 0.1, while in FIG. 11, the factor k has a value of 0.7. By comparing these two figures, it is clearly noted that the total number of sections considered is much smaller with a lower value of k.

In all these cases, the Dijkstra algorithm is used in an advantageous manner to determine the scores of the various nodes and establish the potential routes, both for the useful portion of the main route and for the secondary route.

FIGS. 1 to 6 illustrate the route determination method using the Dijkstra approach. In fact, today there are various approaches and various algorithms that make it possible to undertake route calculations. The present invention is capable of being used with a large number of them. For example, the method according to the invention is particularly suited to the Dijkstra algorithm, which is widespread in the field of route calculations.

Generally, according to this approach, a plurality of potential roads is identified from which a route is elected on the basis of given criteria, the identification of the plurality of roads being performed by selecting a first modeling element for the road network, preferably a node, in proximity to the starting point, and a second modeling element for the road network, preferably a node, in proximity to the finishing point; identifying a plurality of roads, each consisting of a plurality of connected road elements from the first element to the second element; and searching for at least one intermediate element for each of said roads in said set of road network modeling elements. This may be a main route and/or a secondary route.

FIGS. 1 to 6 illustrate such a principle. Consider a graph, such as that of FIG. 1, representing the road network, comprising nodes connected together by scored sections (distance between the nodes):

A starting point (for example H) is chosen; the Dijkstra algorithm ascertains for each node the shortest distance between this node and H. FIGS. 1 to 6 illustrate the operation of the algorithm:

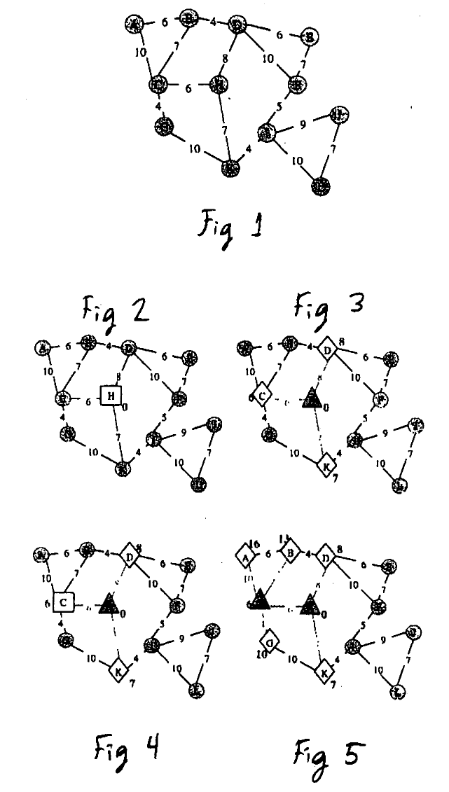

First step (FIG. 2): the starting node is scored at 0.

Second step (FIG. 3): each section leaving the start is followed and the nodes encountered are scored.

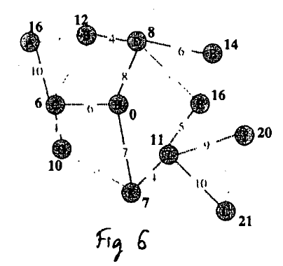

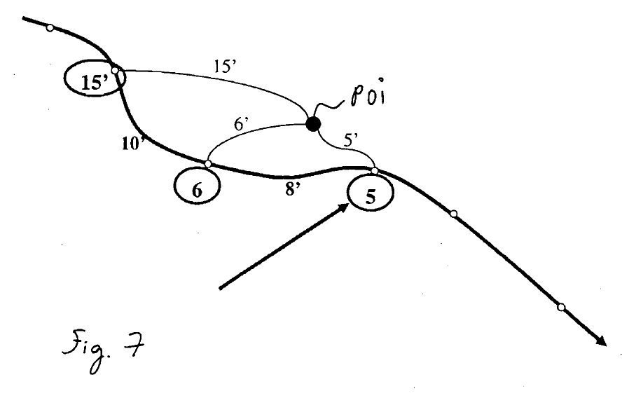

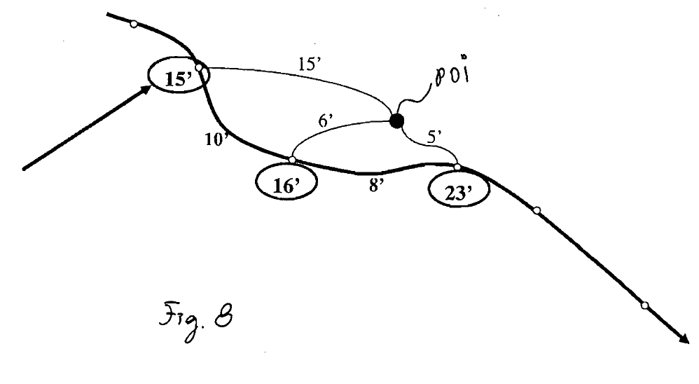

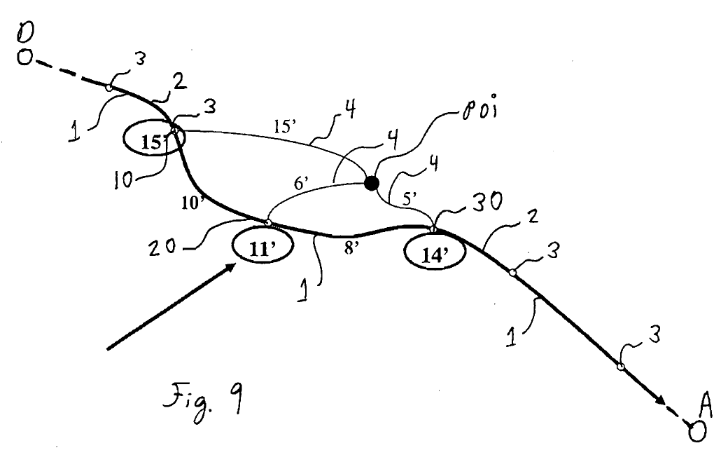

Third step (FIG. 4): from among the scored nodes, the one with the lowest score is selected.

Fourth step (FIG. 5): all the sections starting from the selected point are followed, and the nodes encountered are scored (first score or updating).

Thereafter K and then, subsequently, all the nodes will be selected. So long as a node is not definitively evaluated, its score can change. For example, B will be scored at 12 via D. At the end, the result presented in FIG. 6 is obtained.

The calculation of routes begins from the starting point—in this example, the point H—and stops as soon as the finishing node is definitively evaluated. The best route has thus been obtained. In order to calculate various possible types of routes, the score associated with the section can depend on various parameters such as for example:

the journey time (the fastest route);

the length (the shortest route);

or a combination of the two.

Various alternatives of the method according to the invention can be carried out or used. For example, the origin of the useful portion of the main route can be the starting point D of the main route.

To circumvent the beginning of the main route, which in general does not affect the results of the various scores of the various POI overall routes, the origin of the useful portion of the main route can be the first intersection point between the main route and one of the potential secondary routes, taking account of the direction of the main route.

The method described above and illustrated also serves as the basis within the framework of the present invention for a method of selecting points of interest (POI) for a digital mapping system in which, on the basis of a main route (previously established or known) a plurality of POI overall routes, determined with the preceding method, is used so as to offer the user a plurality of POIs with their respective modes of access. Specifically, the method previously described can, according to an advantageous variant, be used with several points of interest. It is then possible to perform the steps previously described in a successive manner, so as to obtain several POI overall routes, each leading to a different point of interest. It is also possible to choose several POI overall routes, and leave the user to choose the one that he prefers to use.

The present invention moreover envisages a route calculation device, comprising the elements necessary for the implementation of the method previously described and illustrated. In an advantageous manner, this device comprises:

a data entry unit, intended to receive the data associated with a starting point and those associated with a finishing point;

an access to a storage unit comprising a set of elements for modeling a road network;

a calculation unit devised to identify a plurality of roads each making it possible to connect the starting and finishing points;

evaluation means to evaluate, for a plurality of potential secondary routes connecting the main route to at least one point of interest, a POI overall route on the basis of at least the following route elements:

a useful portion of main route and a corresponding score, said score being assigned a factor “k”, the value of said factor “k” lying between 0.1 and 0.7, and preferably between 0.3 and 0.5;

the chosen secondary route and a corresponding score;

and making it possible to choose, from all the evaluated POI overall routes, the POI overall route whose resulting score is optimal.

It is important to note that this route selection principle is entirely consistent with the natural behavior of a motorist in a region that he is largely or completely unfamiliar with: he seeks to avoid very minor roads as he goes along, while nevertheless being constrained to follow them to reach certain types of POIs, which means that he has to deviate from the previously established main route.

1. A method for determining routes for a digital road network system stored on a memory medium and comprising a plurality of sections and of positioning indications for these sections, said sections being capable of being arranged in a reconstruction of a road network so as to form road portions and junctions, in which method, on the basis of a main route connecting a starting point, selected from a database, to a finishing point, also selected from a database, said route being constructed from sections and possibly nodes, said sections connecting said nodes, said method furthermore making it possible to reach at least one point of interest (POI) reachable by a plurality of secondary routes intersecting the main route, an optimal POI overall route is determined by performing the following steps:
a POI overall route is evaluated for each of the potential secondary routes on the basis of at least the following route elements:
a useful portion of main route and a corresponding score, said score being assigned a factor “k”, the value of said factor “k” lying between 0.1 and 0.7, and preferably between 0.3 and 0.5,
the chosen secondary route and a corresponding score;
the POI overall route whose resulting score is optimal is chosen from the set of evaluated POI overall routes.

2. The method for determining routes as claimed in claim 1, in which the POI overall route comprises said useful portion of main route combined with the chosen secondary route.

3. The method for determining routes as claimed in claim 1 or 2, in which the optimal score is the lowest.

4. The method for determining routes as claimed in claim 1 or 2, in which the score corresponds to the journey time.

5. The method for determining routes as claimed in claim 1 or 2, in which the origin of the useful portion of the main route is the starting point of the main route.

6. The method for determining routes as claimed in claim 1 or 2, in which the origin of the useful portion of the main route is the first intersection point between the main route and one of the potential secondary routes, taking account of the direction of the main route.

7. The method for determining routes as claimed in claim 1 or 2, in which the network also comprises nodes, making it possible, in a representation of the road network, to join together a plurality of sections.

8. The method for determining routes as claimed in claim 1 or 2, in which in order to determine the route, a plurality of potential roads is identified from which a route is elected on the basis of given criteria, the identification of the plurality of roads being performed by selecting a first modeling element for the road network, preferably a node, in proximity to the starting point, and a second modeling element for the road network, preferably a node, in proximity to the finishing point; identifying a plurality of roads, each comprising a plurality of connected road elements from the first element to the second element; and searching for at least one intermediate element for each of said roads in said set of road network modeling elements.

9. The method for determining routes as claimed in claim 1 or 2, in which the route is determined with the aid of a Dijkstra algorithm.

10. The method for determining routes as claimed in claim 1 or 2, in which the route is determined with the aid of the FORD algorithm.

11. A POI selection method for a digital mapping system in which, on the basis of a main route connecting a starting point, selected from a database, to a finishing point also selected from a database, said route being constructed from sections and possibly nodes connecting said sections, in which a plurality of POI overall routes, determined with the method according to claim 1 or 2, is used to select a plurality of POI's.

12. A piece of software comprising code elements programmed for the implementation of the method as claimed in claim 1 or 2, when said piece of software is loaded into a computer system and executed by said computer system.

13. The piece of software as claimed in claim 12, in the form of a product recorded on a medium readable by a computer system, comprising programmed code elements.

14. Route calculation device, comprising:
a data entry unit, intended to receive the data associated with a starting point and those associated with a finishing point;
an access to a storage unit comprising a set of elements for modeling a road network;
a calculation unit devised to identify a plurality of roads each making it possible to connect the starting and finishing points;
evaluation means, making it possible to evaluate, for a plurality of potential secondary routes connecting the main route to at least one point of interest, a POI overall route on the basis of at least the following route elements:
a useful portion of main route and a corresponding score, said score being assigned a factor “k”, the value of said factor “k” lying between 0.1 and 0.7, and preferably between 0.3 and 0.5;
the chosen secondary route and a corresponding score;
and making it possible to choose, from the set of evaluated POI overall routes, the POI overall route whose resulting score is optimal.

15. The device as claimed in claim 14, comprising a guidance unit devised so as to generate guidance information as a function of the mapping elements of the selected route.

16. A computer system comprising a device as claimed in one of claims 14 or 15.
